(19) United States
(12) Patent Application Publication
(10) Pub. No.: US 2011/0132229 A1
(43) Pub. Date: Jun. 9, 2011

(54) Coating composition and process for preparing it

(76) Inventor: Lauri Ylikorpi, Vantaa (FI)

(21) Appl. No.: 13/000,589

(22) PCT Filed: Jun. 17, 2009
(86) PCT No.: PCT/FI09/50528

§ 371 Date: Feb. 7, 2011

(30) Foreign Application Priority Data
Jun. 27, 2008 (FI) 20085659

(51) Int. Cl. C09D 7/12

(52) U.S. Cl. 106/287.14

(57) ABSTRACT

The invention relates to an acid-free coating composition comprising one or more fluoroalkylsilane compounds, volatile substance, salt and water, a process for preparing it and its use. Applied to a substrate, the coating composition provides an easy-to-clean and dirt-repellent surface.

### BACKGROUND OF THE INVENTION

The invention relates to a coating composition, a process for preparing it, and its use. Particularly, the invention relates to a coating composition having hydrophobic, oleophobic and dirt-repellent properties, to a process for preparing it, and to its use.

Compositions providing an easy-to-clean surface for various material surfaces have been widely described in literature in the field. US patent publication 2006/0185555 A1, for example, discloses a two-component coating system which, when applied to smooth surfaces, gives an easy-to-clean surface. The first component of the system comprises fluoroalkylsilane, alkylsilane or a mixture thereof, and the second component comprises water, an organic or inorganic acid and a solvent. Each component is prepared separately, combined with each other and mixed for 2 minutes, after which the mixture is ready to be used. The system is applicable to windscreens, glass-walled shower cubicles, glass facades, wall tiles and sanitary ceramics.

WO publication 2007/068545 A2 relates to a storage-stable coating composition which is abrasion and weather resistant and which gives, when applied to smooth surfaces, an easy-to-clean surface. The composition comprises hydrolyzable fluoroalkylsilane, hydrochloric acid as catalyst of hydrolysis and condensation, water, isopropanol and solvent. The composition is applicable to metal, glass, ceramic substances and glazed surfaces, such as windscreens, glass-walled shower cubicles, glass facades, wall tiles and sanitary ceramics.

US patent publication 2004/0005469 A1 describes a process for preparing a product with a long-lasting, easy-to-clean surface. The surface is coated with a coating mixture comprising a gel-forming metal oxide, such as SiO₂, and hydrophobic agent evenly distributed in a metal oxide network structure. Silicones, silanes, siloxanes, silicone oils and silicone greases are suitable to be used as the hydrophobic agent. The coating mixture is prepared by dissolving the hydrophobic agent in a solvent and by adding concentrated hydrochloric acid and water to this mixture. A metal oxide gel coating is prepared for the surface of the product with a sol-gel method, the gel being formed on the surface in situ during the application of the coating mixture. The coating mixture is applicable to metals, plastics, inorganic substances, rocks and particularly glass and glass porcelain.

As known, silicone-based compositions which can be prepared to have a neutral pH without using an acid may also be used as dirt repellents. A problem with surfaces treated with silicone is that they are difficult to after-treat, which is due to the known surface-tension-reducing effect of the silicones. It has turned out that it is virtually impossible for paint, for example, to adhere to a silicone-based surface due to the extensive water and oil repelling property of the surface.

A problem with the above-described compositions containing silane is that the compositions contain strong acid which is required for activating silane in order to achieve the desired properties for the coating when the composition is applied to the surface of a substrate. Owing to the presence of the strong acid, the composition is strongly acidic, due to which treatment of the composition requires particular care. On the other hand, due to their acidic nature, the compositions are not applicable to all surfaces because they are corrosive. Problems arise particularly with metals, such as aluminium, and plastics, in which case the strongly acidic composition reacts with different functional groups of plastics.

Further, a problem with compositions already on the market is their restricted preservability and insufficient durability on the surface of a product. It can be assumed that a silane activated with an acid is not capable of forming sufficiently long silane chains to form a gel-like network structure, which would guarantee a good abrasive resistant surface for the end product, but partial decomposition of silane also takes place in the acid activation. This results in a short silane chain and there will be no durable network structure formed by long silane chains.

### BRIEF DESCRIPTION OF THE INVENTION

An object of the invention is thus to provide a coating composition with high wear and scratch resistance when applied to a surface and giving, at the same time, an easy-to-clean and dirt-repellent surface to the end product. A further object of the invention is to provide a coating composition which the end user finds easy to handle and which is applicable to being applied to all types of surfaces. The object of the invention is achieved with a coating composition which is characterized by what is stated in the independent claims. Preferred embodiments of the invention are disclosed in the dependent claims.

The invention is based on the idea that the fluorosilane compound in the coating composition is activated without an acid by means of a salt solution.

An advantage of the coating composition according to the invention is that the composition to be applied has a neutral pH, i.e. approximately 6 to 7, which means that it is easy to handle. Further, a neutral composition without corrosive properties is applicable to all types of surfaces, such as glass, ceramic substances, rocks, concrete, metals, rubber, thermoplastics and thermosetting plastics, such as polycarbonates, ABS plastics, polypropylene, copolymers of propylene and ethylene, polyurethane and epoxies as well as to painted surfaces.

The coating composition is also storage-stable and provides a durable coating when applied to a product.

### DETAILED DESCRIPTION OF THE INVENTION

In accordance with the present invention, a smooth durable coating with homogeneous properties through the whole cross direction of the coating is provided by applying to the surface of the product a composition containing an agent with easy-to-clean properties. Thus, in accordance with one aspect, the invention relates to a coating composition comprising one or more fluoroalkylsilane compounds, volatile substance, salt and water.

In this invention, one or more fluoroalkylsilane compounds is/are used as an agent with dirt-repellent properties. These are available as commercial products, for example under trademark DYNASYLAN® F 8261 (tridecafluorooctyltriethoxysilane) from the company Degussa AG. Usable fluoroalkylsilanes have the general formula

F₃C(CF₂)ₘ(CH₂)ₙSiR¹_{y}X_{(3-y)}

where X is chlorine or RO, and R is a linear or branched alkyl group with 1 to 4 carbon atoms, R¹ is a linear or branched or cyclic alkyl group with 1 to 8 carbon atoms, n is 0 or 2, y is 0, 1 or 2, and m is 0 to 18.

The amount of fluoroalkylsilane compound in the composition is 0.1 to 10% by weight, preferably 2 to 3% by weight, more preferably 0.5 to 1.5% by weight, based on the total composition.

In accordance with the invention, a solvent or a diluter is used as the volatile substance. These include alcohols, for example methanol, ethanol, isopropanol, n-butanol and white spirit, esters, such as ethyl acetate, ethers, glycols and glycol ethers. Mixtures of said substances may also be used. Preferably, isopropanol is used. The amount of volatile substance in the composition is 50 to 80% by weight, preferably 70 to 80% by weight.

In this invention, the fluoroalkylsilane compound is activated by means of salt, water, alcohol and the oxygen present. For instance methanol, ethanol, isopropanol, n-butanol or white spirit may be used as the alcohol. Oxygen of air appropriately serves as the oxygen source. Activation of the fluoroalkylsilane compound refers, in this invention, to hydrolysis of the silane compound, which means that the compound decomposes into a colloidal suspension, i.e. a sol, in the liquid, and the compound is brought to an active state in order for it to be capable of forming a durable network structure while it is gelled on the surface of the substrate. The activation is appropriately carried out in a tank. It is essential in the activation that the amount of oxygen present in the tank is approximately 10 to 40% by volume, preferably approximately 40% by volume, based on the total volume of the composition. The activation stage takes about 38 to 72 hours, after which the composition is ready to be used.

Inorganic salt, in particular, is used as salt in the coating composition according to the invention. Particularly appropriate salts include halides of alkali metals and alkali earth metals, particularly chlorides. In an embodiment of the invention, NaCl is used as salt. The amount of salt in the composition is 0.25 to 0.75% by weight.

The amount of water in the composition is 5 to 45% by weight, preferably about 20% by weight.

Further, suspending agent may be added to the ready-for-use, activated coating composition, whereby the rate of gelling on the surface of the substrate can be controlled in a desired manner by selecting an appropriate suspending agent on the basis of the evaporation rate. The desired evaporation rate may vary depending on which substrate the coating composition is applied to. In coating metals, for example, it may be desirable that the gelling take place slowly. Alcohols, for example ethanol, isopropanol, n-butanol and white spirit, ketones, for example acetone, for example ethyl acetate, ethers and hydrocarbons, for example xylene, may be used as the suspending agent. It can be mentioned, by way of example, that when the substrate is a metal or PVC plastic, it is appropriate to use n-butanol as the suspending agent. A suitable suspending agent for polyurethane and polyester plastics is xylene. Acetone is also suitable for polyesters. Ethyl acetate and ketones are suitable for acryl-based plastics.

5 to 100% by weight of suspending agent is added to the coating composition activated in the above-described manner. The content of the suspending agent in the coating composition is thus approximately 4 to 50% by weight of the amount of the total composition.

The pH of the coating composition according to the invention is in the neutral range, i.e. approximately 6 to 7.

The invention also relates to a process for preparing a coating composition of the above-described type, the process comprising

mixing the salt and the water to obtain a salt solution

mixing the silane compound and the volatile substance to obtain a mixture

mixing said salt solution and said mixture with each other to obtain a raw composition

allowing the raw composition to stand for 38 to 72 hours, obtaining thus an activated coating composition

adding, if desired, suspending agent to the activated coating composition.

In forming the salt solution of salt and water, it is important to take into account that the pH of the salt solution is neutral.

The coating composition according to the invention is applied to the surface of the substrate by means of what is called a sol-gel method. In the activation of the fluoroalkylsilane compound in the volatile substance in accordance with the invention, polycondensation of the compound takes place, whereby long silane chains are formed and a colloidal suspension, i.e. a sol, is provided. The obtained sol is then applied to the substrate, whereby, along with the evaporation of the volatile substance, the surface of the substrate is provided in situ with a gel network structure in which the silane compound is evenly distributed in the cross direction of the whole gel structure. As presented above, the rate of the gel formation may be controlled, if desired, by means of the suspending agent present.

The coating composition according to the invention provides a durable gel coating for the substrate at the room temperature within 35 to 45 minutes from the application. However, several factors affect the gelling time, such as the surrounding humidity, and great humidity may slow down the gelling. Gel formation on the surface of the substrate may be accelerated, if desired, with heat treatment. Heat treatment may be performed at a temperature of 45 to 80° C. for 15 minutes, for example.

Other substances may be added to the coating composition according to the invention to provide desired properties. For example, hexadecyl trimethoxysilane may be added to the composition in an amount of 1 to 5% by weight on weight basis of the composition, in which case the end product is provided not only with easy-to-dean properties but also a particularly good moisture barrier. Such a coating composition is applicable to metals, plastics and concrete as well as to other porous surfaces.

The coating composition according to the invention may be applied to the substrate with any known technique, such as by spraying, with a roll, by wiping with a cloth, by embedding, brushing or draw coating. The thickness of the network-structured coating composition on the surface of the end product is approximately 1 to 5 nm.

The invention also relates to the use of a composition according to the invention or a composition prepared with a process according to the invention on the surface of the substrate, wherein a durable, easy-to-clean surface is provided. Glass, ceramics, rock, concrete, metal, rubber or many thermoplastics or thermosetting plastics, such as PU, PVC, PE and PP, may be used as the substrate.

The following examples illustrate the invention.

### Example 1

Formulation 1. 12.5 g of NaCl salt is mixed into 1 000 g of ultrapurified water manually or with a mechanical stirrer until the salt is completely dissolved in the water, and the mixture is clear.

Formulation 2. 1.0 g of fluoroalkylsilane (DYNASYLAN® F 8261 from the company Degussa AG) is mixed into 100 g of isopropanol manually or with mechanical stirrer until the a clear solution is obtained.

20 g of formulation 1 and the obtained formulation 2 (101 g) are mixed with each other for about 10 minutes. The obtained mixture is stored in a tank for activation of the silane in such a way that 30 to 40% by volume of air space remains in the tank, based on the amount of solution. The silane is allowed to be activated for 72 hours. The excess salt is filtered off from the solution, after which the solution is ready to be used.

### Example 2

40 g of n-butanol is added to 100 g of the activated product prepared in Example 1. A coating composition is obtained which gives an extremely tong-lasting wear resistant coating to metals.

### Example 3

5 g of xylene is added to 100 g of the activated product prepared in Example 1. The obtained composition is mixed into polyurethane-polyester-based paint. A highly moisture resistant and hydrophobic surface is obtained.

### Example 4

5 g of acetone is added to 100 g of the activated product prepared in Example 1. The obtained composition gives polyester resins good moisture resistance and hydrophobicity.

### Example 5

### Determining Wash Resistance of Coating

An example illustrates the durability of the coating composition according to the invention on the surface of a window glass. The coating composition was applied with a cloth and allowed to be gelled on the surface of the glass for 24 hours, after which the wash resistance of the coating was determined by means of a brush according to the standard SFS 3755, when applicable. The pieces to be tested were brushed 5 000 times. After each 1 000 times, a contact angle was measured from the pieces, and the durability of the coatings was assessed by means of it. The test conditions were as follows:

Device: Braive Instruments

Brush: DIN 53778

Lubricant: water

Temperature: 23° C.

In Table 1, sample A represents the coating composition according to the invention, prepared in the manner described in Example 1. Sample B is a reference composition in which formulation 2 was prepared in the same way as in Example 1 but formulation 1 was prepared by adding 0.5 g of 33.3-% hydrochlorid acid to 10 g of ultrapurified water. Formulations 1 and 2 were combined, after which the obtained composition was allowed to be activated for 10 hours. Likewise, sample C is a reference composition, i.e. the silicone-based acid-activated product DYNASYLAN® F 8263 from the company Degussa AG.

The results of the test are given in Table 1. The contact angle of the water drop remaining on the glass was measured in the test.

TABLE 1
CONTACT ANGLES

| | | 1000 | 2000 | 3000 | 4000 | 5000 |
|---|---|---|---|---|---|---|
| | | brush- | brush- | brush- | brush- | brush- |
| | Start | ings | ings | ings | ings | ings |
| Sample | 110.47° | 111.37° | 113.12° | 113.80° | 109.23° | 112.97° |
| A | | | | | | |
| Sample | 117.17° | 110.32° | 112.48° | 112.02° | 100.57° | 99.28° |
| B | | | | | | |
| Sample | 108.48° | 119.18° | 135.52° | 104.00° | 112.00° | 109.42° |
| C | | | | | | |

It turned out in the test that water was gathered as larger drops on the glass coated with the coating composition according to the invention than on the glasses coated with the reference compositions. Generally speaking, large drops move, as known, more easily on the surface of glass than small drops, although the contact angle of small drops is larger than that of large drops. A large contact angle, in turn, indicates that the surface energy of the drop is low, which means that the drop moves easily on the surface. A small contact angle, in turn, refers to high surface energy, in which case the drop moves more slowly on the surface. Although the contact angle of the coating composition according to the invention (sample A) was smaller than the contact angle of reference sample B before the test was started, the surface energy in sample A was, surprisingly, lower than in B from the start, which is shown by formation of large drops on the glass surface. Thus, when the coating composition according to the invention is used, self-cleaning of the glass is more efficient than with reference compositions. This effect has a practical significance for instance when using the coating in the windscreen of a car, in which case drizzle or washing water does not remain as small drops on the surface of the glass, which would deteriorate visibility, but it is gathered as larger drops on the surface. Deteriorated visibility is particularly harmful when one is driving in the dark, in which case the reflection of external lights from small drops may be significant.

It can also be seen from the results that the contact angle of the coating composition according to the invention (sample A) became, surprisingly, even larger as the glass brushing times increased. It can be assumed that decomposition of the gel structure takes place in sample B during the test, and the gel structure is not capable of “correcting itself”, i.e. being reformed on the surface of the substrate. No such decomposition is observed in sample A but the gel structure is capable of being reformed over time. This phenomenon can partly be explained by the coating composition according to the invention being gelled more slowly than an acid-activated coating composition (sample B).

The results thus show that the coating composition according to the invention was preserved well on the glass surface. In contrast, a coating containing acid-activated fluoroalkylsilane is not preserved on the glass in the same way but some wear can be observed on the basis of the test results.

It is obvious to a person skilled in the art that as the technology advances, the basic idea of the invention can be implemented in a plurality of different ways. The invention and its embodiments are thus not confined to the above examples but may vary within the claims.

1. An acid-free coating composition having a pH in the range of about 6 to 7, comprising one or more fluoroalkylsilane compounds, a volatile substance, NaCl salt and water.

2. The coating composition according to claim 1, wherein the amount of the silane compound in the composition is 0.1 to 10% by weight, preferably 2 to 3% by weight, more preferably 0.5 to 1.5% by weight, based on the total composition.

3. The coating composition according to claim 1, wherein the volatile substance is an alcohol, ester or a mixture thereof.

4. The coating composition according to claim 3, wherein the alcohol is isopropanol.

5. The coating composition according to claim 1, wherein the amount of volatile substance is 50 to 80% by weight, preferably 70 to 80% by weight, based on the total composition.

6. (canceled)

7. The coating composition according to claim 1, wherein the amount of salt is 0.25 to 0.75% by weight.

8. The coating composition according to claim 1, wherein the amount of water is 5 to 45% by weight, preferably approximately 20% by weight.

9. The coating composition according to claim 1, further comprising suspending agent.

10. The coating composition according to claim 9, wherein the suspending agent is an alcohol, ketone, ester or hydrocarbon.

11. The coating composition according to claim 9, wherein the amount of the suspending agent is 4 to 50% by weight, based on the total composition.

12. A process for preparing a coating composition according to claim 1, the process comprising
mixing the salt and the water to obtain a salt solution;
mixing the silane compound and the volatile substance to obtain a mixture;
mixing said salt solution and said mixture with each other to obtain a raw composition;
allowing the raw composition to stand for 38 to 72 hours, obtaining thus an activated coating composition; and
if desired, adding a suspending agent to the activated coating composition.

13. A use of a composition according to claim 1 on the surface of a substrate, wherein a durable, easy-to-clean and dirt-repellent surface is provided.

14. The use according to claim 13, wherein the substrate is glass, ceramics, rock, concrete, metal, rubber, thermoplastic or thermosetting plastic.

15. A use of a coating composition prepared with a process according to claim 12 on the surface of a substrate, wherein a durable, easy-to-clean and dirt-repellent surface is provided.

16. The use according to claim 15, wherein the substrate is glass, ceramics, rock, concrete, metal, rubber, thermoplastic or thermosetting plastic.
